(19) United States
(12) Patent Application Publication
(10) Pub. No.: US 2022/0229013 A1
(43) Pub. Date: Jul. 21, 2022

(54) MULTICAPILLARY ELECTROPHORESIS DEVICE, AND SAMPLE ANALYSIS METHOD

(71) Applicant: HITACHI HIGH-TECH CORPORATION, Tokyo (JP)

(72) Inventors: Noriyuki SUMIDA, Tokyo (JP); Takashi ANAZAWA, Tokyo (JP); Michiru FUJIOKA, Tokyo (JP); Motohiro YAMAZAKI, Tokyo (JP); Taro NAKAZAWA, Tokyo (JP)

(21) Appl. No.: 17/614,619

(22) PCT Filed: Jun. 6, 2019
(86) PCT No.: PCT/JP2019/022449

§ 371 Date: Nov. 29, 2021

(51) Int. Cl. G01N 27/447; G01N 21/64

(52) U.S. Cl. CPC G01N 27/44721; G01N 21/6428

(57) ABSTRACT

A multicapillary electrophoresis device includes: a capillary array formed by arranging a plurality of capillaries; a light source irradiating the capillaries with excitation light; a photodetector detecting fluorescence from a sample in the capillaries; and an arithmetic control unit calculating a signal intensity of the fluorescence according to a signal from the photodetector. The arithmetic control unit is configured so as to correct the signal intensity according to a correction index determined for each of the combinations of any of the capillaries and a fluorophore labeled to the sample.

### TECHNICAL FIELD

The present invention relates to a multicapillary electrophoresis device and a sample analysis method.

### BACKGROUND ART

As a technique for analyzing a base sequence or a base length of DNA, electrophoresis methods are widely known. One of the electrophoresis methods is a capillary electrophoresis method in which electrophoresis is performed in a capillary tube (hereafter, referred to as “capillary”). In the capillary electrophoresis method, a sample containing DNA is injected into a capillary filled with a separation medium and in this state, a high voltage is applied across the capillary. At this time, the DNA as a charged particle negatively charged migrates toward the anode side in the capillary, being dependent on its own size and as a result, a band corresponding to a molecular weight is produced in the capillary. Each DNA is fluorescently labeled and emits fluorescence by irradiation with excitation light. A plurality of fluorescent dyes may be used. A base sequence or a base length of the DNA is determined by detecting them.

For the purpose of acceleration of an analysis, a capillary array with a plurality of capillaries arranged in a single electrophoresis device may be used. Such an electrophoresis device is also referred to as multicapillary array electrophoresis device and an arrangement of a plurality of capillaries is also referred to as capillary array.

One of methods for irradiating such a capillary array with light is a detection method in which fluorescence is detected by applying excitation light (for example, laser light) from one end or both ends of the capillary array so that the light passes through the capillaries. In this case, the laser light passes through the arranged capillaries one after another. When the laser light passes through some capillary, the laser light is scattered at an interfacial boundary between substances different in refractive index (for example, a material of the capillary and air) and the laser light is attenuated. For this reason, laser light applied to a capillary close to a light source among the capillaries is highest in intensity and laser light applied to a far capillary is reduced in intensity. For this reason, a fluorescence intensity detected at each capillary is varied depending on a distance from the light source.

In such a multicapillary-type electrophoresis device, even when an identical amount of DNA is analyzed at each capillary, an obtained fluorescence intensity varies from capillary to capillary. Hereafter, a difference in fluorescence intensity between capillaries produced even when identical amounts of DNA are analyzed will be expressed as “configurational variation.”

Such a configurational variation makes it difficult to make a quantitative comparison of fluorescence intensity obtained by an analysis between capillaries. To cope with this problem, Patent Literature 1 adopts a method in which an elapsed time for light is varied from capillary to capillary. Patent Literature 2 proposes a method in which a fluorescence intensity is corrected using an internal standard reference material.

However, even by the methods in Patent Literatures 1 and 2, it is difficult to accurately make a quantitative comparison of fluorescence intensity between a plurality of capillaries.

### CITATION LISTS

### Patent Literature

Patent Literature 1: Japanese Unexamined Patent Application Publication No. 2012-168138
Patent Literature 2: Japanese Unexamined Patent Application Publication No. 2016-176764

### SUMMARY OF INVENTION

### Technical Problem

The present invention has been made in consideration of the above problem and it is an object of the present invention to provide a multicapillary electrophoresis device and a sample analysis method that enable a quantitative comparison between a plurality of capillaries.

### Solution to Problem

A multicapillary electrophoresis device according to an aspect of the present invention includes: a capillary array formed by arranging a plurality of capillaries; a light source irradiating the capillaries with excitation light; a photodetector detecting fluorescence from a sample in each capillary; and an arithmetic control unit computing a signal intensity of the fluorescence according to a signal from the photodetector. The arithmetic control unit is configured to correct the signal intensity according to a correction index determined for each combination of any of the capillaries and a fluorophore labeling the samples.

A multicapillary array electrophoresis device according to another aspect of the present invention includes: a capillary array formed by arranging a plurality of capillaries; a light source irradiating the capillaries with excitation light; a photodetector detecting fluorescence from a sample in each capillary; an arithmetic control unit configured to compute a signal intensity of the fluorescence according to a signal from the photodetector and correct the signal intensity according to a correction index determined for each of the capillaries; a correction index computation unit computing the correction index. The correction index computation unit irradiates the capillaries with excitation light and measures Raman light and computes the correction index based on a signal intensity of the Raman light.

In a sample analysis method according to an aspect of the present invention, a sample is analyzed using a multicapillary electrophoresis device including a plurality of capillaries. The sample analysis method includes: a step of causing electrophoresis of the sample via the capillaries; a step of, using a photodetector, detecting fluorescence produced by irradiating the capillaries with excitation light; a step of computing a signal intensity of the fluorescence according to a signal from the photodetector; and a step of correcting a signal intensity of the fluorescence according to a correction index determined for each combination of any of the capillaries and a fluorophore labeling the sample.

In a sample analysis method according to another aspect of the present invention, a sample is analyzed using a multicapillary electrophoresis device including a plurality of capillaries. The sample analysis method includes: a stop of causing electrophoresis of the sample via the capillaries; a step of, using a photodetector, detecting fluorescence produced by irradiating the capillaries with excitation light; a step of computing a signal intensity of the fluorescence according to a signal from the photodetector; a step of irradiating the capillaries with excitation light, measuring Raman light, and computing the correction index based on a signal intensity of the Raman light; and a step of correcting a signal intensity of the fluorescence according to the correction index.

### Advantageous Effects of Invention

According to the present invention, a multicapillary electrophoresis device and a sample analysis method that enable a quantitative comparison between a plurality of capillaries.

### BRIEF DESCRIPTION OF DRAWINGS

FIG. 1 is a schematic diagram explaining a configuration of a multicapillary electrophoresis device according to First Embodiment;

FIG. 2 is a block diagram explaining a configuration of a photoirradiation unit 108 in more detail;

FIG. 3 is a flowchart explaining a procedure for a sample analysis in a multicapillary electrophoresis device in First Embodiment;

FIG. 4 is a schematic diagram explaining a method for computing a correction coefficient in First Embodiment;

FIG. 5 is graphs indicating a result of an experiment;

FIG. 6 is a schematic diagram explaining Second Embodiment;

FIG. 7 is a schematic diagram explaining Third Embodiment;

FIG. 8 is a schematic diagram explaining Fourth Embodiment;

FIG. 9 is a schematic diagram explaining Fifth Embodiment; and

FIG. 10 is a schematic diagram explaining Sixth Embodiment.

### DESCRIPTION OF EMBODIMENTS

Hereafter, a description will be given to the embodiments of the present invention with reference to the accompanying drawings. In the accompanying drawings, functionally identical elements may be marked with identical reference signs. The accompanying drawings illustrate embodiments and examples of implementation in accordance with the principle of the present disclosure. However, the accompanying drawings are for understanding the present disclosure and should not be used to limitedly interpret the present disclosure at all. The description in the present specification is just a typical example and do not limit the claims or application examples of the present disclosure in any sense.

The embodiments of the present embodiments are described in detail sufficient for persons skilled in art to implement the present disclosure. However, it should be understood that any other implementation and embodiment is possible and modifications to the configuration and structure and substitution of various elements can be made without departing from the scope of the technical philosophy or the spirit of the present disclosure. Therefore, the following description should not be limitedly interpreted.

### First Embodiment

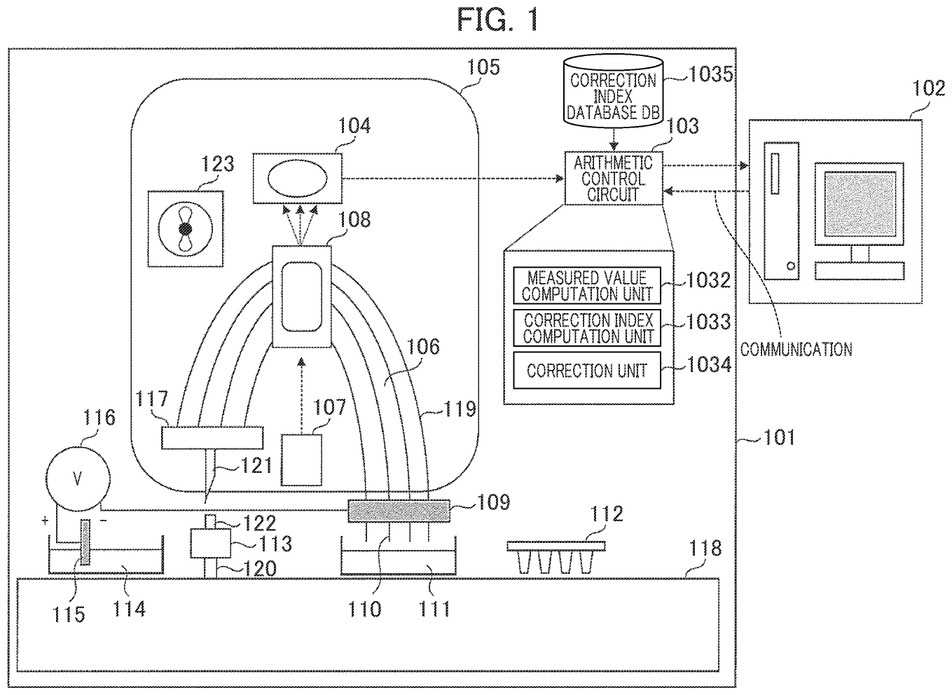

A description will be given to a configuration of a multicapillary electrophoresis device according to First Embodiment with reference to the schematic diagram in FIG. 1. The multicapillary electrophoresis device 1 includes a device main body 101 and a control computer 102.

The device main body 101 is connected with the control computer 102 via a communication cable and an operator operates the control computer 102 to control each part provided in the device main body 101 and receives data detected with the photodetector 104 at the control computer 102. The control computer 102 includes a display as a data display screen for displaying received data. The control computer 102 may be involved in the device main body 101.

The device main body 101 further includes an arithmetic control circuit 103, a photodetector 104, a thermostatic bath 105, a capillary array 106, a light source 107, and a photoirradiation unit 108.

The arithmetic control circuit 103 performs arithmetic processing on a measured value (fluorescence intensity) based on a detection signal from the photodetector 104 and makes correction on a measured value (fluorescence intensity). The arithmetic control circuit 103 controls the device main body 101 according to an input or an instruction from the control computer 102. The photodetector 104 is an optical sensor detecting fluorescence produced by laser light as excitation light applied from the light source 107 to the capillary array 106. As the light source 107, a liquid laser, a gas laser, or a semiconductor laser can be appropriately used and LED may also be used instead. The light source 107 may apply excitation light from both sides of the arrangement of the capillary array 106 or may be configured to apply excitation light in a time-devised manner.

The thermostatic bath 105 is a temperature control mechanism for controlling a temperature of the capillary array 106. The thermostatic bath 105 is clad with a heat insulating material for keeping the interior of the bath at a constant temperature and controls temperature by a heating and cooling mechanism 123. As a result, a temperature of the major part of the capillary array 106 is maintained at a constant temperature, for example, approximately 60° C.

The capillary array 106 is formed by arranging a plurality (four in the example in FIG. 1) of capillaries 119. The capillary array 106 can be configured as a replaceable member that can be replaced with a new one when damage or degradation in quality is recognized. The capillary array 106 may be substituted for by another multicapillary array having a different number of capillaries or capillaries different in length depending on measurement.

Each of the capillaries 119 constituting the capillary array 106 is formed of a glass tube several tens to several hundreds of μm in inside diameter and several hundreds of μm in outside diameter. For the enhancement of strength, the surface of each glass tube can be clad with a polyimide film. However, the polyimide film is removed from the surfaces of the capillaries 119 at a spot irradiated with laser light and the vicinity of such a spot. The capillaries 119 are filled with a separation medium for separating DNA molecules in a biological specimen (sample). An example of the separation medium is a polyacrylamide separation gel (hereafter, referred to as polymer) commercially available for electrophoresis from various companies.

The photoirradiation unit 108 is disposed at a part of the capillary array 106. As described later, the photoirradiation unit 108 is configured to be capable of launching laser light (excitation light) from the light source 107 into the capillaries 119 in common and guiding fluorescence emitted from the capillaries 119 to the photodetector 104. Specifically, the photoirradiation unit 108 has a projection optical system including an optical fiber, a lens, and the like for applying laser light as a measuring beam to a photoirradiation area provided in the capillary array 106.

The device main body 101 further includes a load header 109, a cathode buffer container 111, a sample container 112, a polymer cartridge 113, an anode buffer container 114, an array header 117, and a conveyor 118.

The load header 109 is provided at one end of the capillary array 106. The load header 109 functions as an electrode (cathode) to which a negative voltage is applied to load a biological specimen (sample) into the capillaries 119. The array header 117 is provided at the other end of the capillary array 106 and the array header 117 bundles a plurality of the capillaries 119 into one. The array header 117 is provided on the underside of the array header with a pointed portion 121 for insertion into the polymer cartridge 113.

The conveyor 118 is configured to place the cathode buffer container 111, the sample container 112, the polymer cartridge 113, and the anode buffer container 114 on the upper face of the conveyor and convey these members. In an example, the conveyor 118 may be provided with three electric motors and linear actuators so that the conveyor can be moved in three axial directions, upward and downward, leftward and rightward, and forward and backward. The cathode buffer container 111 and the anode buffer container 114 are containers holding a buffer for migration and the sample container 112 is a container holding a specimen (sample) to be measured.

The polymer cartridge 113 is a container holding a polymer for migration. The polymer cartridge 113 has its upper part 122 enclosed with such a high-plasticity material as rubber or silicone and is coupled with a syringe mechanism 120 for charging a polymer and the conveyor 118. In the anode buffer container 114, an anode 115 for application of a positive voltage for migration is disposed in contact with a buffer. A direct-current power supply 116 is connected between the anode 115 and the load header 109 as a cathode.

The conveyor 118 conveys the cathode buffer container 111 and the sample container 112 to the cathode ends 110 of the capillaries 119. At this time, in conjunction therewith, the anode buffer container 114 moves to the pointed portion 121 equivalent to the anode ends of the capillaries 119. The sample container 112 contains the same number of sample tubes as that of the capillaries 119. An operator dispenses DNA into the sample tubes.

The arithmetic control circuit 103 further includes a measured value computation unit 1032, a correction index computation unit 1033, a correction unit 1034, and a correction index database 1035.

The measured value computation unit 1032 computes a measured value (fluorescence intensity) based on a detection signal from the photodetector 104. The correction index computation unit 1033 computes a correction index for correcting a measured value computed at the measured value computation unit 1032. The correction unit 1034 computes a measured value corrected by applying a correction index to a measured value of the measured value computation unit 1032. The correction index database 1035 is a database storing thus computed correction indexes.

A procedure taken to charge a polymer from the polymer cartridge 113 into the capillaries 119 is as follows:

(1) The conveyor 118 is actuated and the array header 117 is moved to above the polymer cartridge 113.

(2) The pointed portion 121 of the array header 117 pierces the upper part 122 of the polymer cartridge 113. At this time, the high-plasticity upper part 122 of the polymer cartridge 113 embraces the pointed portion 121 of the array header 117 to bring them into tight contact with each other and as a result, the polymer cartridge 113 and the capillaries 119 are hermetically coupled with each other.

(3) The syringe mechanism 120 pushes up a polymer in the polymer cartridge 113 to inject the polymer into the capillaries 119.

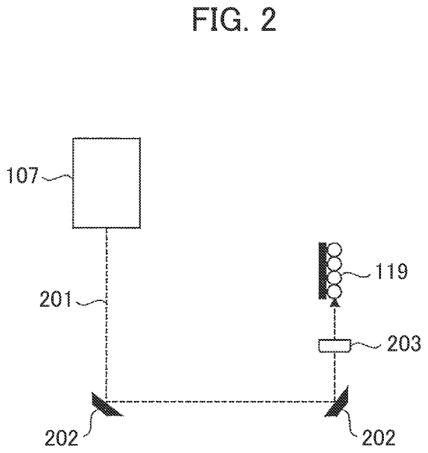

A more detailed description will be given to a configuration of the photoirradiation unit 108 with reference to FIG. 2. In an example, the photoirradiation unit 108 is constituted of a plurality of reflecting mirrors 202 and a condenser lens 203. The reflecting mirrors 202 are reflecting members for changing a traveling direction of laser light from the light source 107. The condenser lens 203 concentrates laser light on a photoirradiation area in the capillary array 106. Any other optical element, such as a filter, a light polarizer, a wave plate, or the like, may be appropriately provided but for the sake of simplicity, a graphic representation of such optical elements is omitted here.

Laser light 201 emitted from the light source 107 is caused to change its traveling direction by the reflecting mirrors 202 and is, after being concentrated by the condenser lens 203, applied to the capillaries 119. The laser light 201 is successively caused to enter the capillaries 119. A fluorescence intensity of fluorescence produced as the result of this entry of the laser light 201 is observed with the photodetector 104 and an analysis of DNA in a sample can be thereby performed.

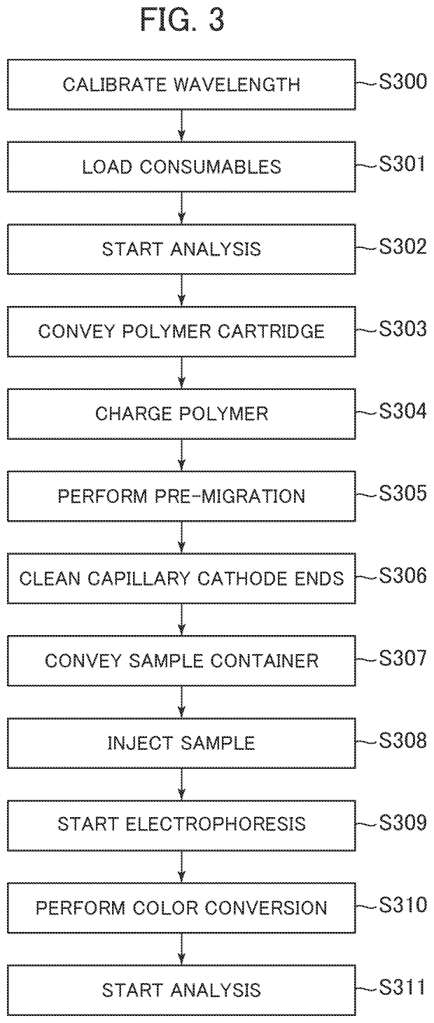

Hereafter, a description will be given to a procedure for analyzing a sample in a multicapillary electrophoresis device with reference to the flowchart in FIG. 3.

At Step S300, before a sample to be analyzed (hereafter, referred to as “actual sample”) is analyzed, first, a wavelength of laser light emitted from the light source 107 is calibrated. In the wavelength calibration, electrophoresis of a known DNA sample (hereafter, referred to as “reference standard”) labeled with the same fluorophore as a fluorophore labeled to the actual sample is caused to obtain wavelength spectrum data as a reference. When the capillary array 106 is replaced in conjunction with deterioration or change in length, this operation is performed without fail.

Subsequently, for advance preparation (loading of consumables), an operator sets the cathode buffer container 111, the sample container 112, the polymer cartridge 113, and the anode buffer container 114 on the conveyor 118 (Step S301). Thereafter, an analysis is started according to an instruction from the control computer 102 by the operator (Step S302).

After an analysis is started, first, the conveyor 118 is actuated to convey the polymer cartridge 113 to the pointed portion 121 of the array header 117 (Step S303). At this time, the capillary cathode ends 110 are brought into contact with a cathode buffer contained the cathode buffer container 111. Thereafter, a polymer is injected into the capillary array 106 by the syringe mechanism (Step S304). At the same time, an old polymer used in a past migration is discarded from the capillaries 119 into the cathode buffer container 111. An amount of a polymer injected from the polymer cartridge 113 into the capillaries 119 is specified by the control computer 102 and the specified amount of the polymer is injected by the syringe mechanism 120.

When charging of the polymer is completed, a pre-migration is subsequently started (Step S305). The pre-migration is performed prior to a proper analysis process in order to bring the polymer in the capillaries 119 into a state suitable for the analysis. The pre-migration is usually performed by applying a voltage of approximately several to several tens of kV to between the anode 115 and the load header 109 for several to several tens of minutes.

After completion of the pre-migration, the capillary cathode ends 110 are cleaned in the cathode buffer container 111 (Step S306). Subsequently, the sample container 112 is conveyed to the capillary cathode ends 110 (Step S307). When a voltage of approximately several kV is applied to the capillary cathode ends 110 in this state, an electric field is produced between a sample liquid and the pointed portion 121 and the sample in the sample container 112 is loaded into the capillaries 119 (Step S308). After loading of the sample, the capillary cathode ends 110 are cleaned in the cathode buffer container 111 again.

Thereafter, a predetermined volage is applied to start electrophoresis of the sample (Step S309). Electrophoresis refers to giving mobility to a sample in the capillaries 119 by the action of an electric field produced between cathode and anode buffers and separating the sample according to a difference in mobility dependent on the properties of the sample. Here, a case where the sample is DNA will be taken as an example to give a description.

DNA has a negative electric charge in a separation medium (polymer) because of a phosphodiester bond as the skeleton of a double helix. For this reason, DNA migrates toward the anode side in the DNA electric field. At this time, since the separation medium (polymer) has a network structure, the mobility of DNA depends on ease of squeezing through the network, in other words, the size of DNA. DNA short in base length easily passes through a network structure and is high in mobility and DNA long in base length is vice versa.

Since DNA is labeled with a fluorescent material (fluorophore) in advance, DNA is optically detected at the photoirradiation unit 108 in the order of shortness of base length. Usually, a measuring time and a voltage application time are set in accordance with a sample longest in migration time. Detected fluorescence is compared with a reference spectrum obtained by the wavelength calibration at 300 to identify the fluorophore. This process is designated as color conversion (Step S310). When a predetermined time has passed after start of voltage application, the voltage application is stopped after data acquisition and the analysis is terminated (Step S311). The foregoing is a basic procedure for electrophoresis analyses. Thus, a value of fluorescence intensity is obtained as a measured value for each of the capillaries 119 at the measured value computation unit 1032 of the arithmetic control circuit 103.

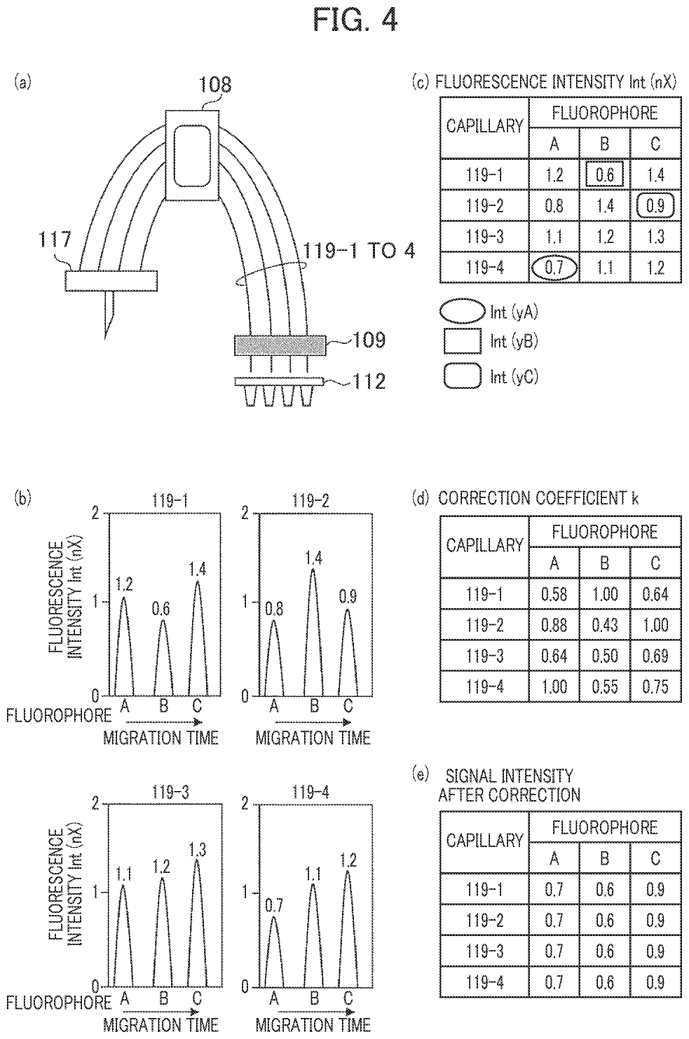

A broad description will be given to a procedure for correcting an obtained measured value (fluorescence intensity) in First Embodiment with reference to the schematic diagram in FIG. 4. In First Embodiment, as mentioned above, with respect to an obtained measured value, a “correction coefficient” as an example of a correction index by which the measured value is to be multiplied is obtained and the measured value is corrected by applying this correction coefficient. A correction coefficient acquired here is provided with a different value for each combination of a plurality of the capillaries 119 and a plurality of fluorophores. In other words, even for an identical capillary 119, a different correction coefficient is given for each different fluorophore when the fluorophores labeled to a sample to be measured are different. Even though used fluorophores are identical, a different correction coefficient is given when the capillaries 119 are different. A suitable example of correction indexes is a correction coefficient by which a measured value is multiplied. However, any correction index is acceptable as long as a measured value can be corrected in accordance with a purpose and a form of a correction index is ignorable.

A description will be given to a method for computing a correction coefficient in First Embodiment with reference to FIG. 4. For the purpose of simplicity, the description will be given on the assumption that the capillary array 106 includes four capillaries 119-1 to 4 (FIG. 4(a)). However, the number of four is just an example and the following description is similarly applicable to cases where any other number is adopted, needless to add. FIGS. 4(b) and (c) illustrate a procedure for computing a correction coefficient and FIG. 4(e) shows an example of a numeric value of fluorescence intensity after correction with the correction coefficient. The numeric values in the tables in FIG. 4(c) to (e) are hypothetical values cited just for the purpose of explanation and are not related to actual measured values.

When wavelength calibration is performed before start of an analysis (Step S300 in FIG. 3), a signal intensity of each of the four capillaries 119-1 to 4 is measured with respective fluorophores. For example, three types of fluorophores A, B, C are used for the fluorophores. During the wavelength calibration, the four capillaries 119-1 to 4 are brought under identical conditions before measurement. For example, an equal quantity of DNA is dispensed into the individual sample tubes corresponding to the four capillaries 119-1 to 4. In this state, ideally, a difference should not be present between the capillaries with respect to fluorescence intensity obtained from wavelength calibration. In reality, however, the above-mentioned “configurational variation” is present between the capillaries. Even in the above circumstances, a significant difference (variation) may be found in fluorescence intensity obtained among the capillaries because of the above and other reasons. To reduce this variation, in First Embodiment, a correction coefficient is computed by the following procedure, stored in the correction index database 1035, and utilized to correct a measured value.

When color conversion is performed on reference spectrum data obtained as the result of the wavelength calibration, fluorescence intensity Int(nX) of each of the fluorophores A, B, C is obtained in each of the capillaries 119-1 to 4 (FIG. 4(b)). Here, n is a number (1 to 4) of the last digit for a capillary and X is a type (A, B, C) of a fluorophore. In FIG. 4(b), a fluorescence intensity of each of the three types of fluorophores A, B, C is obtained in each of the four capillaries 119-1 to 4. For example, in measurement using the fluorophore A, fluorescence intensity Int(1A), Int(2A), Int(3A), Int(4A) is obtained with respect to the four capillaries 119-1 to 4. In measurement using the fluorophore B, fluorescence intensity Int(1B), Int(2B), Int(3B), Int(4B) is obtained with respect to the four capillaries 119-1 to 4. In measurement using the fluorophore C, fluorescence intensity Int(1C), Int(2C), Int(3C), Int(4C) is obtained with respect to the four capillaries 119-1 to 4.

Here, among fluorescence intensity Int(nA), Int(nB), Int(nC) of the fluorophores A to C, one having the smallest value is defined as lowest fluorescence intensity Int(yA), Int(yB), Int(yC). In the example in FIG. 4(b), with respect to the fluorophore A, fluorescence intensity Int(4A)=0.7 of the capillary 119-4 is the lowest fluorescence intensity Int(yA); with respect to the fluorophore B, fluorescence intensity Int(1B)=0.6 of the capillary 119-1 is the lowest fluorescence intensity Int(yB); and with respect to the fluorophore C, fluorescence intensity Int(2C)=0.9 of the capillary 119-2 is the lowest fluorescence intensity Int(yC).

In First Embodiment, the lowest fluorescence intensity Int(yA), Int(yB), Int(yC) is taken as a reference value and a correction coefficient k(nX) is computed by dividing each measured value by this reference value. For example, a correction coefficient k(nA) for the fluorophore A is computed by k(nA)=Int(yA)/Int(nA). A correction coefficient k(nB) for the fluorophore B is computed by k(nB)=Int(yB)/Int(nB). A correction coefficient k(nC) for the fluorophore C is computed by k(nC)=Int(yC)/Int(nC). Thus, a correction coefficient k(nX) is computed with respect to each of 12 combinations in total of a plurality of the capillaries 119-1 to 4 and a plurality of the fluorophores A to C.

As indicated in FIG. 4(d), the correction coefficient k(nX) associated with the lowest fluorescence intensity Int(yX) takes the highest value of 1.00. Meanwhile, with respect to each of the fluorophores A to C, the smallest correction coefficient k(nX) is given to a combination of the highest fluorescence intensity. In FIG. 4(d), numeric values of correction coefficient are rounded off to the second decimal place but the present invention is not limited to this. Obtained correction coefficients k(nX) are stored in the correction index database 1035.

In the example in FIGS. 4(c) and (d), correction coefficients are computed with the lowest fluorescence intensity Int(yX) taken as a reference value but the present invention is not limited to this. For example, an average value, a maximum value, or a median value of fluorescence intensity or a numeric value in some specific capillary may be representatively used in calculation.

After a correction coefficient k(nX) is obtained with respect to each combination of the capillaries 119-1 to 4 and the fluorophores A to C, electrophoresis of an actual sample is caused to obtain a fluorescence intensity f(nX). By multiplying this fluorescence intensity f(nX) by the correction coefficient k(nX) obtained as indicated in FIG. 4(d), a fluorescence intensity f′(nX) after correction can be obtained as indicated in FIG. 4(e).

A fluorescence intensity f(nX) before correction has variation between different capillaries even when an identical fluorophore is used to measure an identical sample. Meanwhile, by multiplying by a correction coefficient k(nX) as indicated in FIG. 4(e), a fluorescence intensity f′(nX) after correction can have a substantially identical value between a plurality of the capillaries 119-1 to 4 with respect to an identical fluorophore.

Correction with a correction coefficient k(nX) need not be so set that a fluorescence intensity f′(nX) after correction is mutually substantially identical. A correction coefficient k(nX) only has to be set to such a value that when the correction coefficient k(nX) is applied (multiplied) to signal intensity associated with a plurality of the capillaries, at least variation in signal intensity after correction between the capillaries is reduced as compared with variation before correction. For measurement with an actual sample, it is desirable to use the same fluorophore as the fluorophore used in wavelength calibration or use fluorophores in common with one another at least in light emission wavelength band for the enhancement of effect of correction.

In the above embodiment, a correction coefficient obtained from wavelength calibration data with a single device is used to correct a measured value at the same device. Instead, a correction coefficient obtained with some specific device can also be used to correct a measured value for an actual sample obtained with a different device.

### EXAMPLE

An effect of an embodiment of the present invention was actually verified using the sample described below:

(Sample)

For a reference standard during wavelength calibration, PowerPlex (registered trademark) 4C Matrix Standard (from Promega Co.) was used. For an actual sample, a sample obtained by amplification with PowerPlex (trademark) 16HS System (from Promega Co.) using human genome DNA provided by Promega Co. as a template was used. The samples were both prepared according to a standard protocol recommended by Promega Co. In this experiment, both of a reference standard and the actual sample were labeled with four different types of fluorophores (5-FAM, JOE, TMR, CXR).

(Analysis Procedure)

In capillary-type electrophoresis, different actual samples are often caused to migrate from capillary to capillary. In this experiment, however, an equal quantity of an identical actual sample was analyzed for all the capillaries to clarify an effect of the present invention. More specifically, an equal quantity of a reference standard used in wavelength calibration or an actual sample was disposed in the sample container 112 of a capillary-type electrophoresis device configured as shown in FIG. 1. A capillary length at the time of migration was 36 cm; an applied voltage at the time of sample injection was 1.6 kV; and an applied voltage at the time of migration was 15 kV.

Color conversion at 311 was performed on data obtained by the wavelength calibration at 300 and a correction coefficient was calculated by the above-mentioned method. Subsequently, migration of the actual sample was performed and comparison was made to see how a fluorescence intensity difference between capillaries varied between before and after the application of the above correction coefficient.

(Experiment Result)

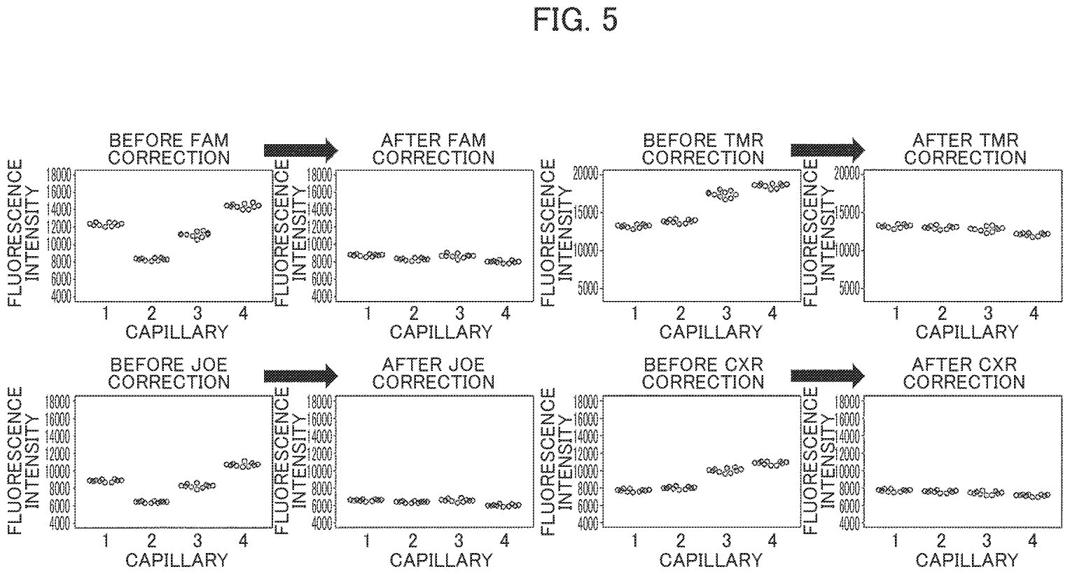

FIG. 5 shows a result of the experiment. In FIG. 5, the vertical axis represents fluorescence intensity and the horizontal axis represents the last digit number of each capillary. Each dot in the drawings indicates fluorescence intensity observed in each amplification product. In this experiment, as mentioned above, an equal quantity of an actual sample was disposed in the sample container. For this reason, in an ideal state, a fluorescence intensity should be identical between the capillaries.

However, a nearly doubled fluorescence intensity difference was observed between the capillaries from observed values before correction (left side). As seen from observed values after correction (right side), it was clearly demonstrated that this fluorescence intensity difference can be leveled by correction in accordance with the present embodiment.

[Modification 1]

A description will be given to Modification 1 to First Embodiment. In First Embodiment, a correction coefficient k(nX) is calculated using data obtained during wavelength calibration (Step S300). In Modification 1, meanwhile, any sample with a known concentration is labeled with fluorophore X and electrophoresis is caused and a correction coefficient k(nX) is calculated using fluorescence intensity data obtained as the result thereof.

It is assumed that a concentration of DNA in a sample with a known concentration used for calculation of a correction coefficient k(nX) is c(nX). Here, n is a number of the last digit for each of the capillaries 119-1 to 4 and X is a type of a fluorophore. Further, it is assumed that an average value obtained by averaging the concentrations c(nX) of DNA in the capillaries is avg(X). Furthermore, a concentration ratio r(nX) of DNA between the capillaries is defined as r(nX)=avg(X)/c(nX).

When the fluorescence intensity of fluorophore X is Int(nX) in each of the capillaries 119, a correction coefficient k(nX) can be calculated by k(nX)=Int(yX)/{r(nX)×Int(nX)}. As in First Embodiment, y is a number for a capillary in which fluorescence intensity is minimized.

When a correction coefficient k(nX) is obtained as mentioned above, a fluorescence intensity f(nX) obtained by measuring an actual sample is multiplied by this correction coefficient k(nX). As a result, a correction can be made as in First Embodiment. In the above description of Modification 1, an average value of concentration c(nX) is used to calculate a correction coefficient k(nX). Instead, a maximum value, a minimum value, or a median value of fluorescence intensity or a numeric value in some specific capillary may be used in calculation.

[Modification 2]

A description will be given to Modification 2 to First Embodiment. In First Embodiment, data obtained during wavelength calibration (Step S300) is used to calculate a correction coefficient k(nX). In Modification 2, meanwhile, any sample with a known concentration ratio is labeled with fluorophore X and electrophoresis is caused. Fluorescence intensity data obtained as the result thereof is used to calculate a correction coefficient.

It is assumed that a concentration ratio of DNA used to calculate a correction coefficient k(nX) is r(nX) and the fluorescence intensity of fluorophore X is Int(X). Here, n is a number of the last digit for a capillary and X is a type of a fluorophore. A correction coefficient k(nX) can be calculated by k(nX)=Int(yX)/{r(nX)×Int(nX)}. As in First Embodiment, y is a number of a capillary in which fluorescence intensity is minimized.

When a correction coefficient k(nX) is obtained as mentioned above, a fluorescence intensity f(nX) obtained by measuring an actual sample is multiplied by this correction coefficient k(nX). As a result, correction can be made as in First Embodiment.

[Modification 3]

A description will be given to Modification 3 to First Embodiment. In First Embodiment, data obtained during a specific wavelength calibration (Step S300) is used to calculate a correction coefficient k(nX). In Modification 2, in Modification 3, meanwhile, a correction coefficient is calculated from a plurality of pieces of wavelength calibration data.

n is taken for a number of the last digit for a capillary is n and X is taken for a type of a fluorophore used and m times of wavelength calibration are performed. It is assumed that an average value Avg(nX) of fluorescence intensity Int(nX) for m times is obtained in this case. A capillary (number y) in which the lowest fluorescence intensity is obtained is identified from obtained n pieces of data of average value Avg(nX) and an average value Avg(yX) therefor is identified. Thus, a correction coefficient k(nX) with fluorophore X can be determined as k(nX)=Avg(yX)/Avg(nX). Thereafter, a fluorescence intensity after correction can be obtained by multiplying a fluorescence intensity f(nX) of an actual sample labeled with fluorophore X by the correction coefficient k(nX). In this example, an average value is used to calculate a correction coefficient but instead, a maximum value, a minimum value, or a median value may be used.

### Second Embodiment

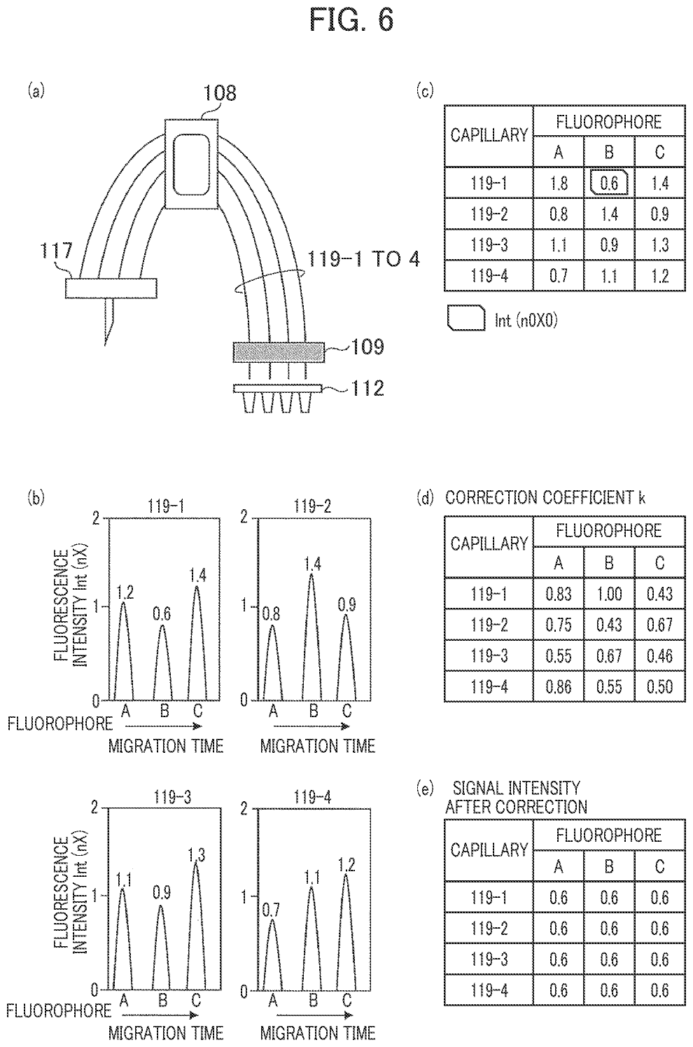

A description will be given to a multicapillary electrophoresis device according to Second Embodiment with reference to FIG. 6. The multicapillary electrophoresis device according to Second Embodiment may be identical in configuration with First Embodiment (FIG. 1) and an overlapped description will be omitted. The embodiments are substantially identical also in overall operation (FIG. 3).

However, Second Embodiment is different from First Embodiment in a technique for computing a correction coefficient. A specific description will be given. In First Embodiment, a correction coefficient is calculated so that when an identical fluorophore is used, fluorescence intensities after correction are substantially identical among a plurality of capillaries or at least variation in fluorescence intensity is reduced. In Second Embodiment, meanwhile, regardless of a difference in capillary or a difference in fluorophore used, a correction coefficient is determined so that fluorescence intensities are substantially identical or at least variation in fluorescence intensity is reduced (significant variation is reduced to a negligeable level) with respect to all the combinations. A description will be given to this with reference to FIG. 6.

Also, in relation to FIG. 6, a case where the capillary array 106 includes four capillaries 119-1 to 4 will be taken as an example for description (FIG. 6(a)). FIGS. 6(b) and (c) show a procedure for computing a correction coefficient and FIG. 6(e) shows examples of numeric values of fluorescence intensity after correction with a correction coefficient. As in FIG. 4, the numeric values in the tables in FIG. 6(c) to (e) are hypothetical values cited just for the purpose of explanation and are not related to actual measured values.

In FIG. 6(a) to FIG. 6(c), as in FIG. 4, a signal intensity of each of the four capillaries 119-1 to 4 is measured with respective fluorophores during wavelength calibration (Step S300 in FIG. 3) before start of an analysis. The steps up to this point are the same as in First Embodiment.

In Second Embodiment, Int(n₀X₀) with the smallest value is identified from among 12 fluorescence intensities Int(nX) obtained with respect to the combinations of the four capillaries 119-1 to 4 and three different types of fluorophores A to C. In FIG. 6(c), Int(n₀X₀) is fluorescence intensity Int(1B) obtained by measurement using fluorophore B in the capillary 119-1. n₀ is a number of the last digit for a capillary in which fluorescence intensity is minimized and X₀ represents a type of a fluorophore with which fluorescence intensity is minimized in that capillary.

In Second Embodiment, a correction coefficient k(nX) is computed by k(nX)=Int (n₀X₀)/Int(nX) relative to this lowest fluorescence intensity Int(n₀X₀). That is, in Second Embodiment, a correction is made not only so that a difference is not produced in fluorescence intensity between a plurality of capillaries but also so that a difference is not produced in fluorescence intensity between a plurality of different types of fluorophores. As a result, a correction is made so that fluorescence intensities are substantially identical or variation in fluorescence intensity is reduced at least as compared with before correction in the combinations of the capillaries and the fluorophores.

FIG. 6(d) indicates examples of the thus calculated correction coefficient k(nX), obtained by dividing the lowest fluorescence intensity Int(n₀X₀) by a fluorescence intensity Int(nX) obtained as indicated in FIG. 6(c). According to the correction coefficient k(nX) in FIG. 6(d), a fluorescence intensity f′(nX) after correction can be obtained as indicated in FIG. 6(e) by multiplying the fluorescence intensity f(nX) of an actual sample labeled with, for example, fluorophore X by k(nX). Unlike First Embodiment, all the fluorescence intensities f′(nX) are matched at 0.6 regardless of the type of fluorophores or the type of capillaries.

### Third Embodiment

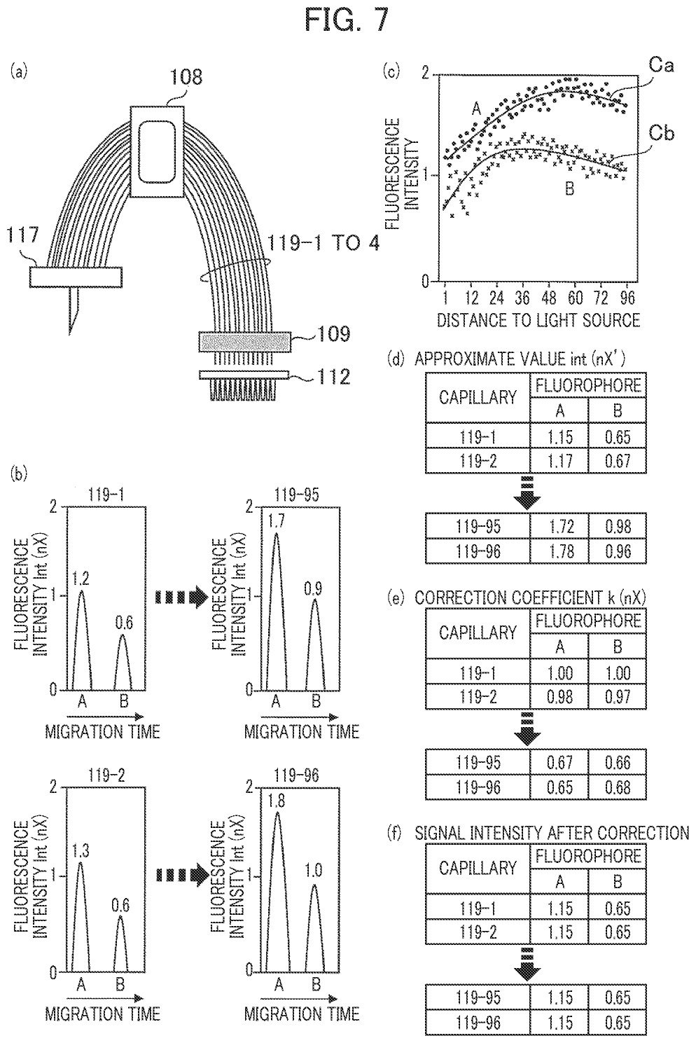

A description will be given to a multicapillary electrophoresis device according to Third Embodiment with reference to FIG. 7. The multicapillary electrophoresis device in Third Embodiment may be identical in configuration with that in First Embodiment (FIG. 1) and an overlapped description will be omitted. The embodiments are substantially identical also in overall operation (FIG. 3). In Third Embodiment, however, instead of calculating a correction coefficient k(nX) using an actual measured value of fluorescence intensity Int(nX), an approximate value based on a fitting curve in accordance with a distribution of fluorescence intensity Int(nX) is determined and a correction coefficient k(nX) is calculated from this approximate value.

A description will be given to a method for computing a correction coefficient in Third Embodiment with reference to FIG. 7. A case where the capillary array 106 including 96 capillaries 119-1 to 96 and two different types of fluorophores A, B are used will be taken as an example for description (FIGS. 7(a) and (b)). The number of 96 is also just an example and any other number is acceptable, needless to add. FIG. 7(b) to (e) illustrate a procedure for calculating an approximate value and further computing a correction coefficient based on this approximate value. FIG. 7(f) indicates examples of numeric values of fluorescence intensity after correction with a correction coefficient. The numeric values in the tables in FIG. 7(c) to (f) are hypothetical values cited just for the purpose of explanation and are not related to actual measured values.

As in First Embodiment, after a fluorescence intensity Int(nX) is obtained from wavelength calibration data (FIG. 7(b)), a scatter diagram with a distance of a capillary from the light source 107 taken as the horizontal axis and a fluorescence intensity Int(nX) taken as the vertical axis is plotted (FIG. 7(c)). Based on the plot of the obtained scatter diagram, a fitting curve Ca, Cb is obtained by, for example, a least squares method with respect to respective fluorescence intensity Int(nA), Int(nB) with fluorophores A, B. An approximate value Int(nX′) of fluorescence intensity is calculated from these fitting curves Ca, Cb with respect to each capillary and each fluorophore (FIG. 7(d)).

When an approximate value Int(nX′) of fluorophore X (A or B) in a capillary with a number of the last digit of n as indicated in FIG. 7(d), for example, a correction coefficient k(nX) can be calculated by k(nX)=Int(yX′)/Int(nX′) (FIG. 7(e)). Here, Int(yX′) indicates the minimum approximate value smallest among the measurements using fluorophore X (A or B). Use of this correction coefficient k(nX) allows an actual measured value f(nX) for an actual sample to be corrected (FIG. 7(f)). In the example shown in FIG. 7 (FIG. 7(d)), the smallest approximate value Int(yX′) is obtained in the first capillary 119-1 with respect to both fluorophores A, B. That is, an approximate value Int(yA′)=Int(1A′)=1.15 and Int(yB′)=Int(1B′)=0.65.

### Fourth Embodiment

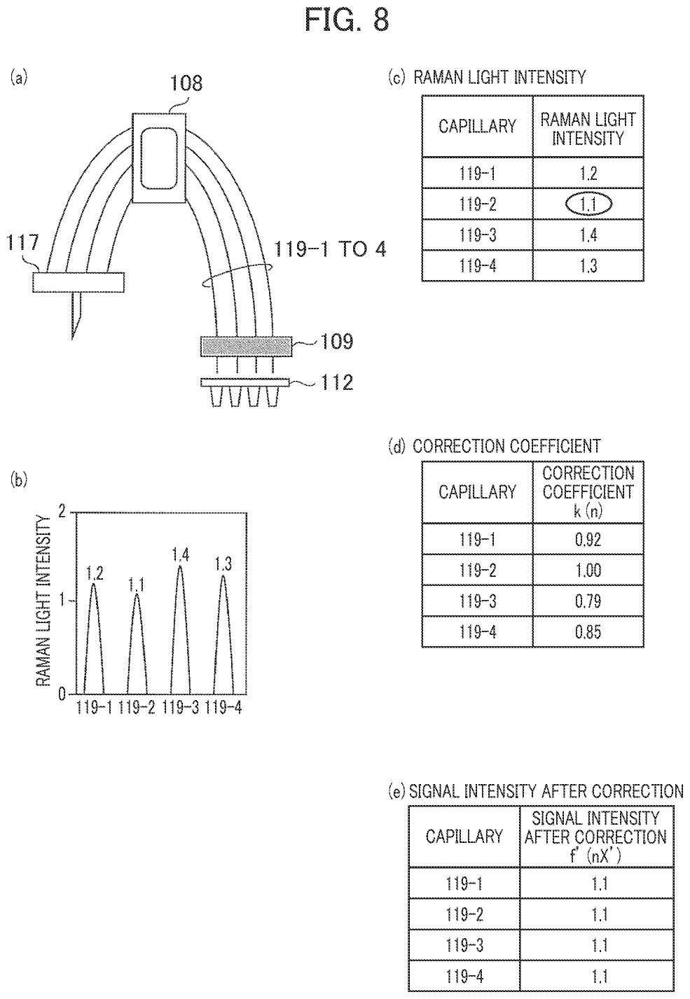

A description will be given to a multicapillary electrophoresis device according to Fourth Embodiment with reference to FIG. 8. The multicapillary electrophoresis device in Fourth Embodiment may be identical in configuration with that in First Embodiment (FIG. 1) and an overlapped description will be omitted. The embodiments are substantially identical also in overall operation (FIG. 3). However, Fourth Embodiment is different from the above-mentioned embodiments in technique for detecting light at the photodetector 104 and a method for calculating a correction coefficient.

A specific description will be given. In the above-mentioned embodiments, a sample labeled with the same fluorophore as that of an actual sample is used to measure fluorescence intensity and a correction coefficient is calculated based on a result of the measurement. In Fourth Embodiment, meanwhile, a plurality of the capillaries 119 are filled with an identical substance (for example, buffer or any other substance (for example, water)) and irradiated with excitation light and an intensity of the Raman light thereof is measured with the photodetector 104 to calculate a correction coefficient. A description will be given to this with reference to FIG. 8. An example of a substance charged into the capillaries 119 to measure the intensity of Raman light is buffer. Hereafter, a description will be mainly given to a case where Raman light from a buffer is measured but the same effect is obtained also by measuring Raman light from any other substance than buffer.

To calculate a correction coefficient, the capillaries 119-1 to 4 are filled with a buffer and then laser light is applied from the light source 107 toward the photoirradiation unit 108. Thereafter, at each of the capillaries 119-1 to 4, Raman light intensity Int(nX) (n=1 to 4) is measured at a specific wavelength X. When an identical buffer is supplied to the capillaries 119-1 to 4, in ideal circumstances, an obtained Raman light intensity Int(nX) should be substantially equal among the capillaries. However, because of configurational variation in the capillaries 119-1 to 4, significant variation can be produced in Raman light intensity Int(nX) with the capillaries 119-1 to 4 (Refer to FIG. 4(b)).

Then, among the Raman light intensities Int(nX) obtained in the individual capillaries 119-1 to 4, that with the lowest signal intensity is identified as lowest Raman light intensity Int(yX). In FIG. 8(c), a Raman light intensity Int(2X) of the second capillary 119-2 is identified as Int(2X)=Int(yX)=1.1.

A correction coefficient k(n) is calculated by k(n)=Int(yX)/Int(nX) relative to this lowest Raman light intensity Int(yX) with respect to each of the capillaries 119-1 to 4 (FIG. 8(d)). The calculated correction coefficients k(n) are stored in the correction index database 1035.

After a correction coefficient k(n) is obtained as mentioned above, a sample to be analyzed (hereafter, referred to as “actual sample”) is caused to migrate to obtain a fluorescence intensity f(nX). A fluorescence intensity f′(nX) after correction can be obtained as indicated in FIG. 8(e) by multiplying this fluorescence intensity f(nX) by a correction coefficient k(n) obtained as indicated in FIG. 8(d). A fluorescence intensity f(nX) before correction involves variation even when an identical sample is measured using an identical fluorophore. By multiplication with a correction coefficient k(n), as indicated in FIG. 8(e), fluorescence intensities f′(nX) after correction can have a substantially identical value among the capillaries 119-1 to 4. That is, a substantially identical fluorescence intensity can be obtained among capillaries under identical conditions regardless of configurational variation among the capillaries.

### Fifth Embodiment

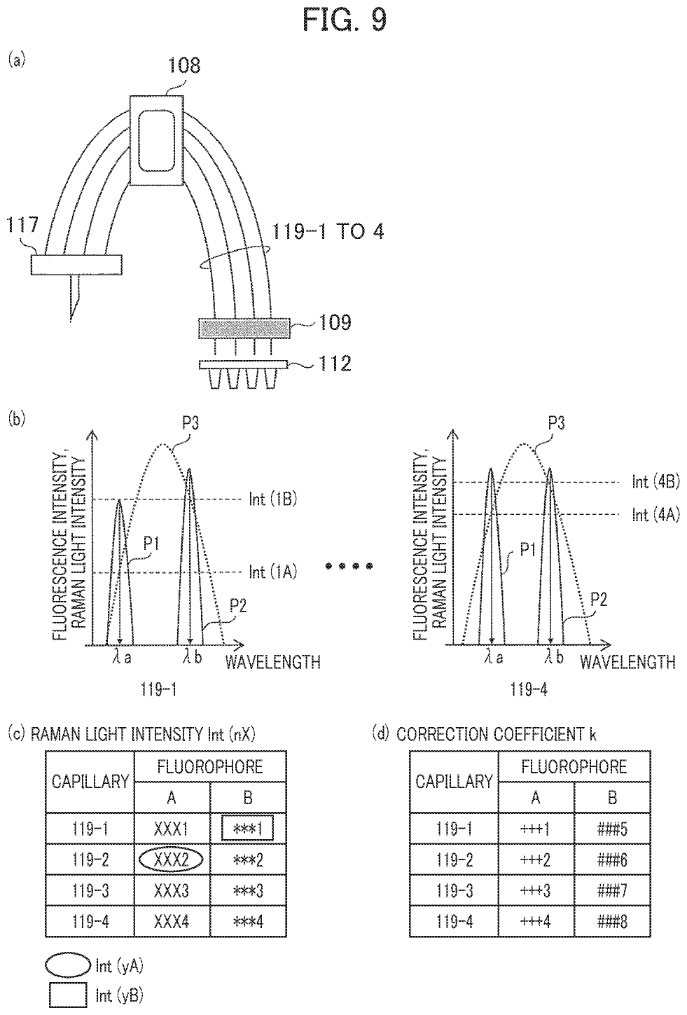

A description will be given to a multicapillary electrophoresis device according to Fifth Embodiment with reference to FIG. 9. Like Fourth Embodiment, Fifth Embodiment is configured so as to calculate a correction coefficient based on Raman light intensity. The multicapillary electrophoresis device in Fifth Embodiment may be identical in configuration with that in First Embodiment (FIG. 1) and an overlapped description will be omitted. The embodiments are substantially identical also in overall operation (FIG. 3). In Fourth Embodiment, signal intensity in the position of a peak in a signal intensity distribution of Raman light of a buffer is used to calculate a correction coefficient. In Fifth Embodiment, meanwhile, signal intensity with a plurality of wavelengths contained in a signal intensity distribution of Raman light of a buffer is used to calculate a correction coefficient. A description will be given to this with reference to FIG. 9.

Also, with respect to FIG. 9, a case where the capillary array 106 includes four capillaries 119-1 to 4 will be taken as an example for description (FIG. 9(a)). FIG. 9(b) to (d) illustrate a procedure for computing a correction coefficient.

To compute a correction coefficient, as in Fourth Embodiment, the capillaries 119-1 to 4 are filled with a buffer and then laser light is applied from the light source 107 toward the photoirradiation unit 108. Thus, as shown in FIG. 9(b), for example, an intensity distribution P3 of Raman light from the buffer is a distribution extending over a wider wavelength range as compared with intensity distributions P1, P2 of fluorescence emitted from a fluorophore.

In Fifth Embodiment, at each of the capillaries 119-1 to 4, Raman light intensity Int(nA), Int(nB) (n=1 to 4) with the wavelength λa, λb of a Raman light intensity distribution P3 is measured. These wavelengths λa, λb are fluorescence wavelengths of fluorophores A, B labeled to an actual sample. When the intensity distribution P3 of Raman light from a buffer overlaps with fluorescence wavelengths λa, λb of fluorophores labeled to an actual sample as indicated in FIG. 9(b), an intensity Int(nA), Int(nB) (n=1 to 4) of Raman light of the buffer at the fluorescence wavelengths λa, λb is measured and a correction coefficient k(nA), k(nB) is calculated based on the Raman light intensity Int(nA), Int(nB). As a result, a fluorescence intensity of an actual sample can be more precisely corrected.

When Raman light intensity Int(nA), Int(nB) (n=1 to 4) is calculated with respect to each of the capillaries 119-1 to 4, subsequently, one having the smallest value among Int(nA), Int(nB) is defined as lowest Raman light intensity Int(yA), Int(yB). In the example in FIG. 9(c), a Raman light intensity Int(2A) of the capillary 119-2 is the lowest Raman light intensity Int(yA) with respect to fluorophore A; and a Raman light intensity Int(1B) of the capillary 119-1 is the lowest Raman light intensity Int(yB) with respect to fluorophore B.

A correction coefficient k(nA), k(nB) is calculated by k(nA)=Int(yA)/Int(nA), k(nB)=Int(yB)/Int(nB) relative to the lowest Raman light intensity Int(yA), Int(yB). A fluorescence intensity of fluorophore A, B is appropriately corrected by multiplying a fluorescence intensity f(nX) of an actual sample labeled with fluorophore X by the thus obtained correction coefficient k(nA), k(nB).

### Sixth Embodiment

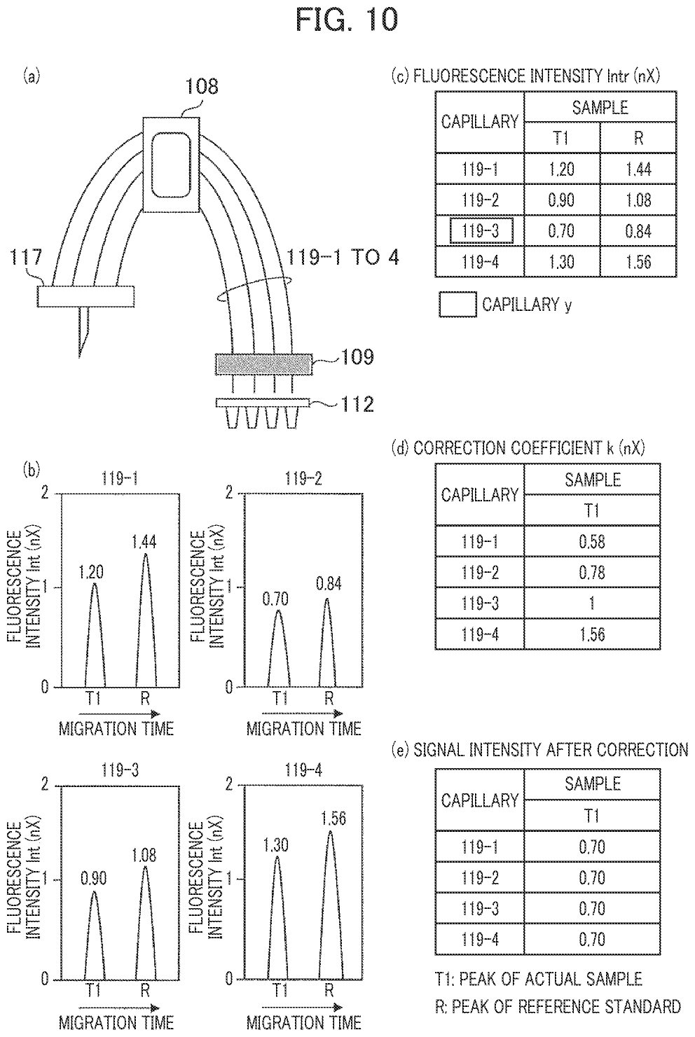

A description will be given to a multicapillary electrophoresis device according to Sixth Embodiment with reference to FIG. 10. In First Embodiment, a correction coefficient is calculated based on a fluorescence intensity obtained by electrophoresis different from electrophoresis of an actual sample (for example, Step S300 in FIG. 2). Meanwhile, the device in Sixth Embodiment is configured so as to calculate a correction coefficient from a fluorescence intensity obtained from electrophoresis of an actual sample. Hereafter, a description will be given to this with reference to FIG. 10.

For the sake of simplicity, in relation to FIG. 10, a description will be given on the assumption that the capillary array 106 includes four capillaries 119-1 to 4 (FIG. 10(a)). FIG. 10(b) to (d) illustrate a procedure for computing a correction coefficient and FIG. 10(e) indicates examples of numeric values of fluorescence intensity after correction with a correction coefficient. The numeric values in the tables in FIG. 10(c) to (e) are hypothetical values cited just for the purpose of explanation and are not related to actual measured values.

First, a reference standard labeled with the same fluorophore as a fluorophore used for labeling an actual sample is mixed with the actual sample. Electrophoresis of this actual sample mixed with the reference standard is caused and a fluorescence intensity of the actual sample is measured as usual. Meanwhile, a fluorescence intensity of the reference standard is also measured in the same process. At this time, the reference standard must be chronologically and spatially discriminable from the actual sample in migration data. As indicated in FIG. 10(b), for example, migration control must be exercised by mixing the reference standard with the actual sample so that a peak Tl of the fluorescence intensity of the actual sample is chronologically different from a peak R of the fluorescence intensity of the reference standard.

After color conversion (equivalent to Step S310 in FIG. 2), an observed fluorescence intensity of the reference standard is taken as Intr(nX). Here, n is the number of a capillary and X is the type of a fluorophore. Among the obtained fluorescence intensities Intr(1X), Intr(2X), Intr(3X), Intr(4X) of the four reference standards, one having the smallest value is defined as lowest fluorescence intensity Intr(yX). In the example in FIG. 10(c), a fluorescence intensity Intr(3X) of the capillary 119-3 is the lowest fluorescence intensity Intr(yX).

When the lowest fluorescence intensity is obtained, a correction coefficient k(nX) is calculated by k(nX)=Int(yX)/Int(nX) as in the above-mentioned embodiments. As in the above-mentioned embodiments, instead of using a minimum value (lowest fluorescence intensity) for calculation, an average value, a maximum value, or a median value of fluorescence intensity can also be used. An intensity difference between fluorophores can be corrected by using the correction coefficient, specifically, multiplying the fluorescence intensity f(nX) of an actual sample by k(nX).

The present invention is not limited to the above-mentioned embodiments and includes various modifications. For example, the above-mentioned embodiments are described in detail for making the present invention understandable and the present invention need not always include all the configuration elements described. Some part of the configuration elements of some embodiment can be replaced with a configuration element of any other embodiment and a configuration element of some embodiment can also be added to the configuration elements of any other embodiment. Some configuration element of each embodiment can be deleted; and some other configuration element can be added thereto and substituted therefor. Each of the above-mentioned configuration elements, functions, processing units, processing means, and the like may be partly or wholly implemented by hardware, for example, by designing it into an integrated circuit.

### LIST OF REFERENCE SIGNS

101 . . . Device main body,
102 . . . Control computer,
103 . . . Arithmetic control circuit,
104 . . . Photodetector,
105 . . . Thermostatic bath,
106 . . . Capillary array,
107 . . . Light source,
108 . . . Photoirradiation unit,
109 . . . Load header,
110 . . . Capillary cathode end,
111 . . . Cathode buffer container,
112 . . . Sample container,
113 . . . Polymer cartridge,
114 . . . Anode buffer container,
115 . . . Anode,
116 . . . Direct-current power supply,
117 . . . Array header,
118 . . . Conveyor,
119 . . . Capillary,
120 . . . Syringe mechanism,
121 . . . Pointed portion,
122 . . . Polymer cartridge upper part,
123 . . . Heating and cooling mechanism,
201 . . . Laser light,
202 . . . Reflecting mirror,
203 . . . Condenser lens

1. A multicapillary electrophoresis device comprising:
a capillary array formed by arranging a plurality of capillaries;
a light source irradiating the capillaries with excitation light;
a photodetector detecting fluorescence from a sample in the capillaries; and
an arithmetic control unit calculating a signal intensity of the fluorescence according to a signal from the photodetector,
wherein the arithmetic control unit is configured to correct the signal intensity according to a correction index determined for each of the combinations of any of the capillaries and a fluorophore labeled to the sample.

2. The multicapillary electrophoresis device according to claim 1,
wherein when the correction index is applied to a signal intensity obtained by measuring an actual sample, the arithmetic control unit sets the correction index so that variation in the signal intensity among the capillaries after application of the correction index is reduced as compared with variation in the signal intensity among the capillaries before application of the correction index.

3. The multicapillary electrophoresis device according to claim 1,
wherein the arithmetic control unit corrects the signal intensity based on a correction index determined for each of the combinations of any of the capillaries and any of a plurality of types of fluorophores.

4. The multicapillary electrophoresis device according to claim 1, further comprising:
a correction index computation unit computing the correction index,
wherein the correction index computation unit computes the correction index based on a signal intensity obtained by giving an identical condition to the capillaries and measuring fluorescence from a sample in the capillaries.

5. The multicapillary electrophoresis device according to claim 4,
wherein the correction index computation unit takes a signal intensity obtained at one of the capillaries as a reference value and calculates, as the correction index, a value obtained by dividing a value of signal intensity obtained at each of the capillaries by the reference value.

6. The multicapillary electrophoresis device according to claim 4,
wherein the correction index computation unit calculates an approximate value of the signal intensity based on a fitting curve of a distribution of the signal intensity and computes the correction index based on the approximate value.

7. The multicapillary electrophoresis device according to claim 4,
wherein the correction index computation unit computes the correction index based on a signal intensity of fluorescence obtained by causing, in the capillaries, electrophoresis of a known sample labeled with the same fluorophore as a fluorophore labeled to an actual sample.

8. A multicapillary electrophoresis device comprising:
a capillary array formed by arranging a plurality of capillaries;
a light source irradiating the capillaries with excitation light;
a photodetector detecting fluorescence from a sample in the capillaries;
an arithmetic control unit configured to calculate a signal intensity of the fluorescence according to a signal from the photodetector and correct the signal intensity according to a correction index determined for each of the capillaries; and
a correction index computation unit computing the correction index,
wherein the correction index computation unit irradiates the capillaries filled with an identical substance with excitation light, measures Raman light of the substance, and computes the correction index based on a signal intensity of that Raman light.

9. The multicapillary electrophoresis device according to claim 8,
wherein the correction index computation unit uses a signal intensity at a specific wavelength contained in a signal intensity distribution of the Raman light to calculate the correction index.

10. The multicapillary electrophoresis device according to claim 9,
wherein the specific wavelength is a fluorescence wavelength of a plurality of types of fluorophores labeled to an actual sample.

11. A sample analysis method for analyzing a sample using a multicapillary electrophoresis device provided with a plurality of capillaries, including the steps of:
causing electrophoresis of the sample via a plurality of capillaries;
detecting fluorescence produced by irradiating the capillaries with excitation light, using a photodetector;
calculating a signal intensity of the fluorescence according to a signal from the photodetector; and
correcting a signal intensity of the fluorescence according to a correction index determined for each of the combinations of any of the capillaries and a fluorophore labeled to the sample.

12. The sample analysis method according to claim 11,
wherein when the correction index is applied to a signal intensity obtained by measuring an actual sample, the correction index is set so that variation in the signal intensity among the capillaries after application of the correction index is reduced as compared with variation in the signal intensity among the capillaries before application of the correction index.

13. The sample analysis method according to claim 11,
wherein the correction index is determined for each of the combinations of any of the capillaries and any of a plurality of types of fluorophores.

14. The sample analysis method according to claim 11, further comprising the step of:
computing the correction index,
wherein at the step of computing the correction index, the correction index is computed based on a signal intensity obtained by giving an identical condition to the capillaries and measuring fluorescence from a sample in the capillaries.

15. The sample analysis method according to claim 14,
wherein at the step of computing the correction index, a signal intensity obtained at one of the capillaries is taken as a reference value and a value obtained by dividing a value of signal intensity obtained at each of the capillaries by the reference value is calculated as the correction index.

16. The sample analysis method according to claim 14,
wherein at the step of computing the correction index, an approximate value of the signal intensity is calculated based on a fitting curve of a distribution of the signal intensity and the correction index is computed based on the approximate value.

17. The sample analysis method according to claim 14,
wherein at the step of computing the correction index, the correction index is computed based on a signal intensity of fluorescence obtained by causing, in the capillaries, electrophoresis of a known sample labeled with the same fluorophore as a fluorophore labeled to an actual sample.

18. A sample analysis method for analyzing a sample using a multicapillary electrophoresis device provided with a plurality of capillaries, comprising the steps of:
causing electrophoresis of the sample via a plurality of capillaries;
detecting fluorescence produced by irradiating the capillaries with excitation light, using a photodetector;
calculating a signal intensity of the fluorescence according to a signal from the photodetector;
irradiating the capillaries filled with an identical substance with excitation light, measuring Raman light of the substance, and computing a correction index based on a signal intensity of that Raman light; and
correcting a signal intensity of the fluorescence according to the correction index.

19. The sample analysis method according to claim 18,
wherein at the step of computing the correction index, a signal intensity at a specific wavelength contained in a signal intensity distribution of the Raman light is used to calculate the correction index.

20. The sample analysis method according to the claim 19,
wherein the specific wavelength is a fluorescence wavelength of a plurality of types of fluorophores labeled to an actual sample.
